(19) United States
(12) Patent Application Publication
(10) Pub. No.: US 2005/0086408 A1
(43) Pub. Date: Apr. 21, 2005

(54) MS silicon card with bi-interface

(75) Inventor: Hsiang-An Hsieh, Hsin-Dien City (TW)

Correspondence Address: TROXELL LAW OFFICE PLLC;SUITE 1404, 5205 LEESBURG PIKE, FALLS CHURCH, VA, 22041, US

(73) Assignee: Carry Computer Eng. Co., Ltd.

(21) Appl. No.: 10/617,802

(22) Filed: Jul. 14, 2003

(30) Foreign Application Priority Data
Feb. 27, 2003 (TW) 092203040

(51) Int. Cl. G06F 13/00

(52) U.S. Cl. 710/301; 711/115; 710/315; 710/313

(57) ABSTRACT

A MS Silicon Card with bi-interface comprises a silicon card and a USB converting device; wherein the silicon card has MS memory card transfer interface with standard specifications and a circuit board with microcontroller and erasable memory media, USB converting device has at least one slot and a USB interface, and the slot can receive the said silicon card, USB interface can connects with the peripheral device, the converting device detects and determines automatically if the MS transfer interface or USB interface are supported by the system allowing the data to store and read in the MS memory card of erasable memory media.

### THE FIELD OF THE UTILITY MODEL

The utility model relates to a silicon card, especially to a MS silicon card with bi-interface by using USB converting device and MS silicon card.

### PRIOR ART

MS (Memory Stick) memory card is a minitype memory or silicon card comprised by erasable memory media and a control wafer that covered in a case. The size of device and electric interface adopt the memory card standard of the new model that was released by SONY corporation in 2000. The MS memory card has been widely spread and used accompany with the share market of every consumed electric device, potable electric device and data home appliances of SONY Group due to the advantages of small bulk, light weight, fast store and read, high capacity etc. so that the traditional store media of disk and CD have been replaced, and becomes the one of the digital new store medias. However, the MS memory card only uses the MS interface that is specially for itself, even SONY can provide every types of specific interface for MS memory card range from every new consumed electric device to potable device or data home appliance that produced by themselves allowing to store and read the digital data stored in the MS memory card. It is impossible to perform the functions of data transfer and convert if user wants to use the MS memory card on a general peripheral system without MS memory card interface, such as desktop system and notebook system. Generally, except using the said transfer function of data home appliance, user has to buy the MS card reading machine (silicon card machine) or converting card having controlling device to perform the data transfer and exchange between the personal computer system and MS memory card. It results in confusion and inconvenient on utilization. Although the interface of the desktop and/or notebook is set to be an extended transfer interface having the same standard—USB interface standard specification, which is a kind of host computer or potable device for extending various extended interface of all around devices. At present all personal desktop computer system and notebook computer system install the inside extended interface due to the advantages of USB interface having high transfer rate, easy install, hot plugging, supporting various all around device etc. The all around devices include: input device (keyboard, mouse, rocker), store device (hard disk, floppy, CD, silicon card), output device (digital speaker), telecommunication device (USB wireless net device, USB connected line).

To find the solution of the said problems or disadvantages, decrease the extra cost of demanding accessional device and avoid the complication on performing in the desktop computer system and notebook computer system, the present utility model allows the said MS memory card to directly connect with the most popular USB extended interface of personal computer system by a converting device with low cost so that the MS memory card can provide the digital data store, transfer and exchange function between the personal computer system and various consumed electric device, potable device, digital home appliance with the simplest device converting, most convenient performance and at the lowest cost.

### DESCRIPTION OF THE UTILITY MODEL

The main objective of the utility model is to convert the MS memory card with specific MS interface into the MS memory card having bi-interface that can detect the system interface and switch to suitable system interface automatically by a suitable method so as to support the most popular store media with USB interface. It has the characters of reducing the system cost greatly (eliminate the needs of extra connecting device), more convenient performance (easy install and operate).

To achieve the said objectives, the utility model provides a MS silicon card with bi-interface, wherein comprises an inside installed microcontroller of the silicon card and its converting device, the silicon card has standard MS interface for using to connect with converting device or peripheral device, the converting device has a slot for receiving the MS silicon card and a USB interface connecting with peripheral system, the preferable character is: except using its own MS interface to store and read data, the microcontroller of the MS silicon card has the functions of automatically detecting and determining if the peripheral device supports the MS transfer interface or USB interface so as to access the peripheral data that store and read in the MS memory card of erasable memory media by USB converting device.

### THE DESCRIPTION OF THE EMBODIMENT

As shown in FIG. 1, the present utility model of MS silicon card with bi-interface and its converting device comprises a silicon card 1 and a converting device 2; wherein the silicon card 1 has a main body on which a first interface 11 (MS transfer interface) having MS memory card standard is provided at a suitable position, and a circuit board 12 (PCB) is provided inside the main body, a microcontroller 13 and a plurality of erasable memory media 14 are provided on the circuit board and are welded on the said circuit board 12 by sticking technology. The microcontroller device 13 has at least one inside installed first bus interface circuit 131 (MS bus interface), the data transfer temporary store buffer 132 and the power converting circuit 133, it further comprises control store and read interface and program code store memory media. The designed principle and structure of the said devices that have been well known by practitioners in the art will not be explained.

The converting device 2 comprises at least a slot having silicon card interface and second transfer interface 21 (USB transfer interface), the slot provides a insertion for the said silicon card 1, and connects with the computer system and or peripheral system with USB extended interface by using the second transfer interface 21 of the converting device 2.

The main character of the utility model is: a second bus interface circuit 134 is provided in the microcontroller 13 of the silicon card 1, and an interface detecting control and switching circuit 135, the first bus interface circuit 131 or the second bus interface circuit 134 for detecting and switching automatically, because the microcontroller 13 has the functions of detecting and switching if the system supports the MS interface or USB interface, the microcontroller 13 will automatically switch the circuit and electric units of the electric board to support the data transfer performance of the first transfer interface of the MS card 1 or the second transfer interface in order to allow the peripheral data can be stored and read in the erasable memory media 14 when the microcontroller 13 of the MS silicon card 1 detects either the first bus interface circuit 131 or the second bus interface circuit 134, thus, a silicon card with bi-interface of both MS and USB has been made.

The FIG. 2 shows the schematic diagram of the detecting, controlling and switching circuit of the utility model. According to the said schematic diagram, it is obviously that the MS silicon card 1 of the utility model applies the functions of the control wafer that is set in the card reading machine or converting card having the traditional control device on the MS silicon card 1 so as to allow the MS silicon card 1 to have at least two different system interface circuit including the signal ports of CLK, SCLK, SDIO, Reserved1, Reserved2 with different functions. The MS silicon card with bi-interface of the utility model uses the two signal groups of Reserved 1 and Reserved 2 as D+ signal and D− signal of connecting USB system interface and detects if the system port uses either the first bus interface 131 or the second bus interface 134 on the base of the SCLK signal, and produces the control signal to operate the signal switching circuit 136 after confirming the performance model.

FIG. 3 and FIG. 4 illustrate that the microcontroller 13 automatically switches to suitable work model on the base of the system performance model detected by the interface control and switching circuit 135 when the power of the MS silicon card with bi-interface turns on, and starts the suitable system interface circuit model according to the said suitable work model switched by the interface control and switching circuit 135. The microcontroller 13 receives the transfer commands and processes them so as to properly respond the action on the base of the standard specification of the system interface circuit after the circuit of the system interface turns on. For example, when the interface detecting control and switching circuit 135 detects that the system circuit is the first bus model, the system starts the standard circle model of the MS silicon card 1, that is, selects the first bus 131 to produce a MS command through its bus Idle 137 to process the command and respond to the Bus Idle 137; contrarily, when the interface detecting control and switching circuit 135 detects that the system circuit is the second bus model, the system starts the standard circle model of the USB interface, and selects the second bus 134 to produce a USB command through its bus Idle 138 to process the command and respond to the Bus Idle 138.

As described above, the present utility model of the MS silicon card with bi-interface performs the functions of automatically detecting, controlling and switching by the microcontroller 13 allowing the MS silicon card 1 to perform the conversion through a USB converting device with low cost so that the MS silicon card can connect with the peripheral system and allow the MS silicon card 1 has the feature of supporting both the MS and USB bi-interface. The present utility model together with computer and other peripheral system provides user a data store and read media at the lowest cost and with the simplest operation.

In summary, the present utility model of the MS silicon card with bi-interface can realize the desired function and the designed consideration, therefore it has the typical characters of structure and utilizations that are different from that of the traditional MS silicon card. Also the present utility model is not disclosed to the public so that, it satisfies the criterion for novelty. This application is proposed according to related acts, it will be appreciated if this utility model is granted paten right.

However, the description as above is only one of the preferred embodiments of the present utility model, any modification according to the spirit of the utility model resulting in the functional changes is the equal alternatives covered by the description and accompany drawings, and should not exceed the scope of the utility model.

### BRIEF DESCRIPTION OF THE DRAWING

FIG. 1 shows the schematic diagram of the control circuit of the present utility model.

FIG. 2 shows the schematic diagram of the detecting, control and switching determine circuit of the present utility model.

FIG. 3 shows the detecting, switching flow diagram of the present utility model.

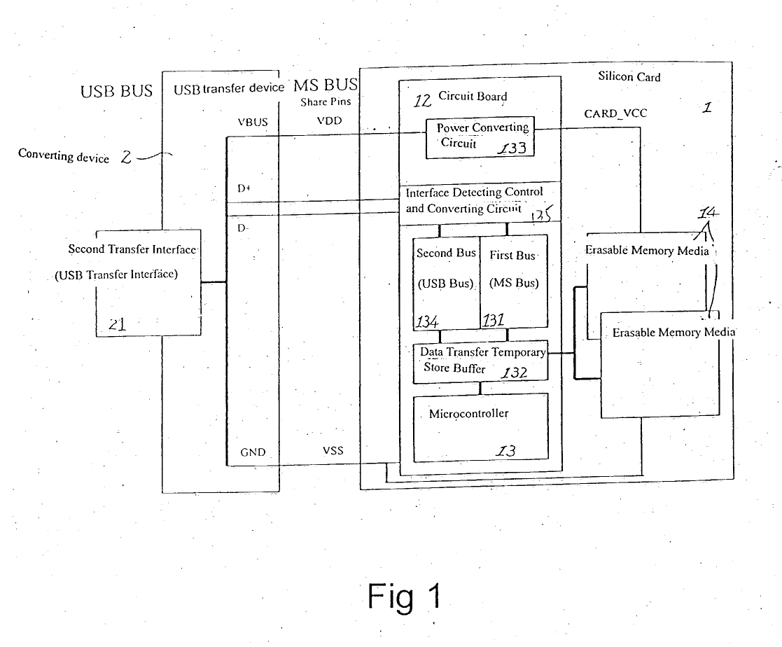

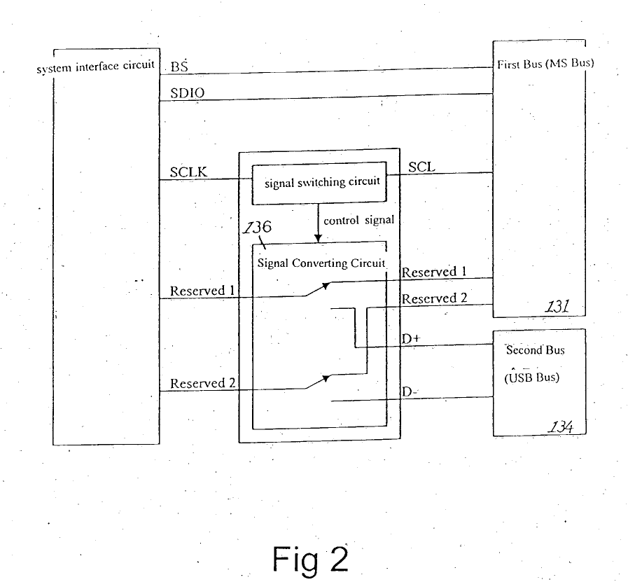

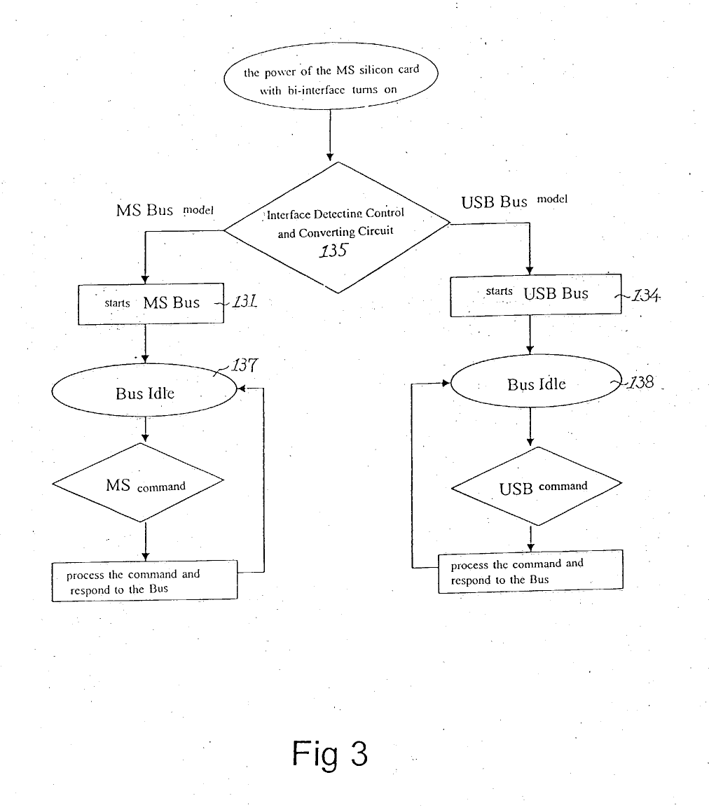

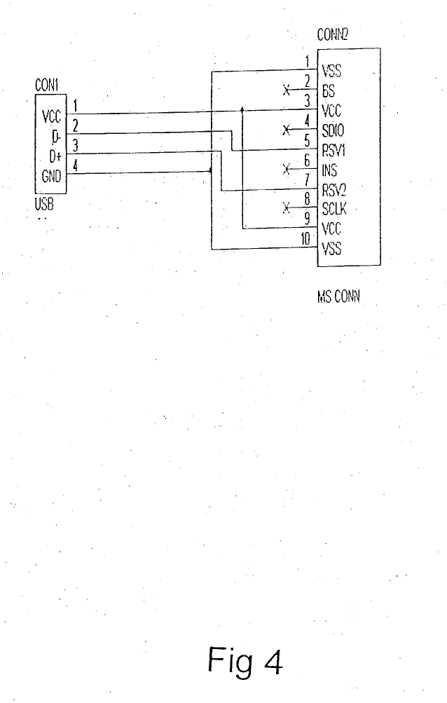

FIG. 4 shows the circuit diagram of the present utility model.
1 silicon card
12 circuit board
13 microcontroller
131 first bus
132 data transfer temporary store buffer
133 power converting circuit
134 second bus
135 interface detecting control and switching circuit
136 signal switching circuit
137, 138 bus idle
14 erasable memory media
2 converting device
21 second transfer interface (USB transfer interface)

1. A MS silicon card with bi-interface comprising: a silicon card and its converting device, wherein the silicon card has a first transfer interface and circuit broad having microcontroller and erasable memory media, a first bus interface is provided in the microcontroller, a slot for receiving the silicon card and a second transfer interface for connecting with peripheral device are provided in the converting device. The preferred character is: another second bus interface circuit and an interface detecting control and switching circuit are provided in the microcontroller of the silicon card, the interface detecting control and switching circuit has the function of allowing the microcontroller to automatically detect and determine that if the system supports either the first transfer interface or the second transfer interface so that the data can be stored and read in the erasable memory media.

2. The MS silicon card with bi-interface of claim 1 wherein the silicon card has the first transfer interface (standard MS transfer interface), and at least the first bus interface circuit (MS bus interface), data transfer temporary store buffer unit and power convert circuit, control store and read interface, program code store memory media are set inside in the microcontroller.

3. The MS silicon card with bi-interface of claim 1 wherein the second transfer interface is a USB transfer interface.

4. The MS silicon card with bi-interface of claim 1 wherein the second transfer interface is a USB bus interface.

5. The MS silicon card with bi-interface of claim 1 wherein the slot of the converting device is designed to have the structure of silicon card interface in order to provide the insertion for the silicon card.

6. The MS silicon card with bi-interface of claim 1 wherein the silicon card has at least two different system interface circuits includes the signal ports of CLK, SCLK, SDIO, Reserved 1, Reserved 2 with different functions.

7. A MS silicon card with bi-interface comprising: a silicon card and its converting device, wherein the silicon card has a MS transfer interface and circuit broad with microcontroller and erasable memory media, MS bus interface is provided in the microcontroller, a slot for receiving the MS silicon card and a USB transfer interface for connecting with peripheral device are provided in the converting device. The preferred character is: Wherein another USB bus interface circuit and a interface detecting control and switching circuit are provided in the microcontroller of the MS silicon card, the interface detecting control and switching circuit has the function of allowing the microcontroller to automatically detect and determine that if the system supports either the MS transfer interface or the USB transfer interface so that the data can be stored and read in the erasable memory media.

8. The MS silicon card with bi-interface of claim 1 wherein the another data transfer temporary store buffer unit, power converting circuit, control store and read interface, and program code store memory media are provided in the microcontroller.
